(19) United States
(12) Patent Application Publication
(10) Pub. No.: US 2012/0158792 A1
(43) Pub. Date: Jun. 21, 2012

(54) AGGREGATED PROFILE AND ONLINE CONCIERGE

(75) Inventors: Matthew Bret MacLaurin, Woodinville, WA (US); Daniel Edward Walther, II, Redmond, WA (US)

(73) Assignee: Microsoft Corporation, Redmond, WA (US)

(21) Appl. No.: 12/970,979

(22) Filed: Dec. 17, 2010

(51) Int. Cl. G06F 17/30

(52) U.S. Cl. 707/802; 707/E17.005

(57) ABSTRACT

Concepts and technologies are described herein for generating an aggregated profile and for providing an online concierge. In accordance with the concepts and technologies disclosed herein, usage of devices, applications, social networking services, web sites, and/or other resources over are tracked by authorized entities and aggregated into an aggregated profile. The aggregated profile can be managed, tuned, and modified by a user associated with the aggregated profile. The aggregated profile also can be used for various purposes including, for example, an online concierge and other purposes. The concierge can provide information from the aggregated profile, if authorized, to requesting entities. The use of the aggregated profile can be used to reduce the mount of input needed form users, to improve or streamline searching or application usage, and/or for other purposes.

### BACKGROUND

Users may interact with electronic resources via a variety of activities conducted with computing devices. These activities may occur at the computing devices over long periods of time and/or with various discrete purposes and/or goals. As such, the activities may occur via varied devices, times, and locations, as well as via access of one or more electronic resources. Because these activities and resources may occur and/or be accessed at varied times, methods, and the like, these activities are generally viewed in a vacuum, wherein each activity is independent of the other.

Because each activity and/or resource usage is viewed independently, users' likes, preferences, and the like, may be irrelevant and/or may be ignored. Viewing each activity independently may be beneficial in certain circumstances, because user purposes and/or goals also change over time. Furthermore, users are hesitant to allow their search habits, usage habits, or the like, to be discovered or analyzed. As such, computers generally continue to approach each activity or resource usage independently.

It is with respect to these and other considerations that the disclosure made herein is presented.

### SUMMARY

Concepts and technologies are described herein for generating an aggregated profile and for providing an online concierge. In accordance with the concepts and technologies disclosed herein, usage of devices, applications, social networking services, web sites, and/or other resources over time can be tracked by an authorized entity such as a profile engine. The profile engine can aggregate tracked information into an aggregated profile. A user associated with the aggregated profile can manage, tune, and modify the aggregated profile, manage permissions associated with the profile and/or with particular information or categories of information in the profile, and/or take other actions with respect to the profile. The aggregated profile can be used for various purposes including, for example, an online concierge. The online concierge can provide information from the aggregated profile, if authorized, to requesting entities, use the information to alter UI layout and content, use the information to alter website or application output, use the information to provide data to websites, search engines, and/or other entities, and the like. The use of the aggregated profile can be used to reduce the amount of input needed form users, to improve or streamline searching or application usage, and/or for other purposes.

According to one aspect, a profile engine is configured to receive social networking data associated with a social networking service and search data generated by a search engine. The social networking data can include data indicating activity and connections associated with the user. The search data can include search histories and other information generated or tracked by the search engine, as well as information compiled from third party services or entities. Additionally, the profile engine is configured to track activity occurring at a client in communication with the profile engine. These and other data are interpreted by the profile engine, and used to build a profile associated with the user.

According to another aspect, the profile and/or data associated with the profile is used to provide an online concierge. The online concierge uses data from the profile to identify user preferences and/or intent with regard to various applications, web sites, resources, searches, and the like. Additionally, the online concierge can use data from the profile to identify entities for inclusion in an implicit social network that includes entities with whom a user communicates frequently. The concierge also may use data from multiple profiles to recognize similarities and make introductions between parties based upon the determined similarities. The profile engine provides a rich permissioning environment for controlling not only what data is tracked, but also what parties are authorized to access the tracked data.

According to various embodiments, the client is configured to execute a traditional operating system, and in other embodiments, the client is configured to execute a web-based operating system. Thus, the client may execute an operating system or other base program that is configured to access web-based or other remotely-executed applications and services to provide specific functionality at the client device. The client therefore may provide various applications and services via a simple operating system or an application comparable to a standard web browser.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for generating an aggregated profile, according to an exemplary embodiment.

FIG. 3 is a flow diagram showing aspects of a method for using an aggregated profile, according to an exemplary embodiment.

FIG. 4 is a user interface diagram showing aspects of an exemplary user interface for modifying an aggregated profile, according to various embodiments.

FIG. 5 is a user interface diagram showing aspects of an exemplary user interface for providing access to an aggregated profile, according to various embodiments.

FIG. 6 is a computer architecture diagram illustrating an exemplary computer hardware and software architecture for a computing system capable of implementing aspects of the embodiments presented herein.

### DETAILED DESCRIPTION

The following detailed description is directed to concepts and technologies for generating an aggregated profile and for providing an online concierge. According to the concepts and technologies described herein, a profile engine is configured to receive social networking data associated with a social networking service, search data generated by a search engine, and/or other data generated by other entities. Additionally, the profile engine recognizes applications and other resources available to and/or accessed by a client in communication with the profile engine. Additionally, the profile engine is configured to track activity occurring at a client in communication with the profile engine. These and other data are interpreted by the profile engine, and used to build a profile associated with the user.

The profile and/or data associated with the profile is used by the profile engine to provide an online concierge. The online concierge is configured to use data from the profile to identify user preferences and/or intent with regard to various applications, web sites, resources, searches, and the like. Additionally, the online concierge is configured to use data from the profile to generate implicit social networks and/or for other purposes. The concierge is configured to use data from multiple profiles to recognize similarities and make introductions between parties based upon the determined similarities. The profile engine also is configured to generate user interfaces for interacting with the profiles and for controlling contents of the profiles. The profile engine also provides a rich permissioning environment for controlling not only what data is tracked, but also what parties are authorized to access the tracked data.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The word “application,” and variants thereof, is used herein to refer to computer-executable files for providing functionality to a user. According to various embodiments, the applications can be executed by a device, for example a computer, smartphone, or the like. Additionally, the computer, smartphone, or other device can execute a web browser or operating system that is configured to access remotely-executed applications and/or services such as web-based and/or other remotely-executed applications, web pages, social networking services, and the like. In some embodiments, the applications, web pages, and/or social networking services are provided by a combination of remote and local execution, for example, by execution of JavaScript, DHTML, AJAX, .ASP, and the like. According to other embodiments, the applications include runtime applications built to access remote or local data. These runtime applications can be built using the SILVERLIGHT family of products from Microsoft Corporation in Redmond, Wash., the AIR and FLASH families of products from Adobe Systems Incorporated of San Jose, Calif., and/or other products and technologies.

For purposes of the specification and claims, the phrase “web application,” and variants thereof, is used to refer to applications that are configured to execute entirely or in-part on web servers and clients. Web applications can include multitier applications that include, but are not limited to, a data tier for storing and/or serving data used by the multitier applications, a logic tier for executing instructions to provide the functionality of the application, and a presentation tier for rendering and displaying the application output and/or interfaces for interacting with the applications. It should be understood that the names of the tiers provided herein are exemplary, and should not be construed as being limiting in anyway.

The word “profile,” and variants thereof, is used herein to refer to data identifying preferences, settings, identities, activity, social networking information, aliases, locations, demographic information, search history, purchasing history, usage history, and/or other aspects of usage associated with a user or other entity. The profile also can include information describing the types of devices used by the user or other entity, permissioning information associated with the user or other entity, and other information describing the user, what data is accessed by the user, when the user accesses the data, why the user accesses data, and/or how the user accesses data. Additional aspects of the profile are disclosed herein and are included in the definition of profile as used herein and in the claims.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for generating an aggregated profile and providing an online concierge will be presented.

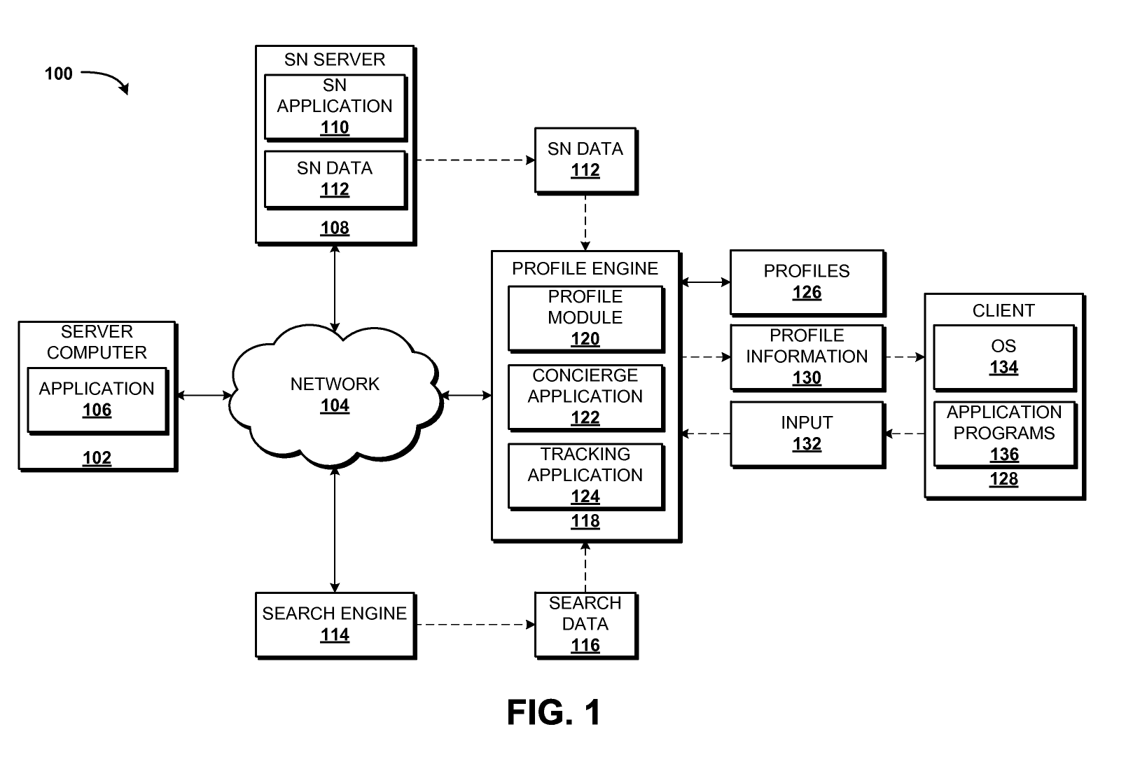

Referring now to FIG. 1, aspects of one operating environment 100 for the various embodiments presented herein will be described. The operating environment 100 shown in FIG. 1 includes a server computer 102 operating on or in communication with a network 104. According to various embodiments, the functionality of the server computer 102 is provided by a web server operating on or in communication with the Internet, though this is not necessarily the case.

The server computer 102 is configured to execute or store an application 106, to host and/or serve web pages, documents, files, multimedia, and/or other content, and/or to host, execute, and/or serve other content, software, and/or services. While the server computer 102 is at times described herein as an application server that executes the application 106 to provide various functionality, it should be understood that this is not necessarily the case. In some embodiments, the server computer 102 executes the application 106 to provide web server functionality, for example by responding to requests for content in response to one or more requests for the content, to execute queries received form devices or entities, and the like. In some implementations, the server computer 102 stores the application 106 and allows other devices and/or network nodes to access, download, and/or execute the application 106. It therefore should be understood that the server computer 102 and the application 106 can be used to provide various functionality including, but not limited to, functionality associated with an application server and/or data server. Additionally, though not illustrated in FIG. 1, it should be understood that the server computer 102 can communicate with and/or include databases, memories, and/or other data storage devices to access, modify, execute, and/or store data associated with the server computer 102 and/or the application 106.

According to various embodiments, data relating to the application 106 is generated by execution of the application 106. Similarly, as mentioned above, the server computer 102 can host or serve data corresponding to content such as web pages, services, documents, files, images, multimedia, software, other content, and the like to devices connecting to the server computer 102 via execution of the application 106. In these and other embodiments, data generated, hosted, and/or served by the server computer 102 can be made available, transmitted to, and/or received by one or more devices connecting to the server computer 102. The devices can be configured to display or render the data to display the content and/or output associated with the application 106, to view files such as audio or video files, to view images, to render web pages or other content, and the like.

It should be understood that in the case of data associated with the application 106, the application 106 can be executed at the server computer 102, and output associated with the application 106 can be rendered and displayed at a device remote from the server computer 102. In other embodiments, the application 106 is executed in part by the server computer 102 and in part by devices remote from the server computer 102 such as computers, servers, and the like to provide functionality associated with the application 106. Thus, while the application 106 is illustrated as being hosted by the server computer 102, it should be understood that application components can be simultaneously executed by one or more devices, for example, to provide multitier applications.

The operating environment 100 also includes a social networking server 108 (“SN server”) operating on or in communication with the network 104. The SN server 108 is configured to execute a social networking application 110 (“SN application”) to provide social networking services to one or more users. Exemplary social networking services include, but are not limited to, the MYSPACE social networking service, the FOURSQUARE geographic networking service, the TWITTER realtime messaging service, the FACEBOOK social networking service, the LINKEDIN professional networking service, the YAMMER office colleague networking service, and the like.

In other embodiments, the SN server 108 provides functionality associated with other services, sites, and/or providers that may not explicitly be known as social networking providers. For example, some web sites allow users to interact with one another via email, chat services, games, reviews, sharing content or bookmarks, comments, threads, blogs, and/or other means, without explicitly providing “social networking services.” Examples of such services include, but are not limited to, review services such as the URBANSPOON restaurant reviewing service, the KUDZU reviewing service, the YELP reviewing service, other reviewing services, and the like. Another example is the WINDOWS LIVE service from Microsoft Corporation in Redmond, Wash. It should be appreciated that the above list of social networking services is not exhaustive, as only exemplary social networking services are mentioned herein for the sake of brevity.

In some embodiments, execution of the SN application 110 by the SN server 108 causes the SN server 108 to generate social networking data 112 (“SN data”) associated with the social networking service and/or associated with one or more users of the SN application 110. In other embodiments, the SN server 108 stores or hosts the SN data 112, which can be collected by the SN application 110 from third party sites, submitted to the SN application 110 by one or more users, and/or otherwise obtained by or transmitted to the SN server 108. The SN data 112 can describe, for example, social networking graphs associated with one or more users, communities and/or networks, social networking user content such as status updates, photographs, reviews, links, videos, and the like, contact and biographical information associated with one or more social networking users, and the like.

In some embodiments, the SN data 112 includes, for example, information describing applications 106 and/or other resources accessed by users of the social networking service, shopping and searching histories and preferences associated with users of the social networking service, articles recommended by users of the social networking services, advertisements, web sites, links, photos, video, audio, combinations thereof, and the like. The SN data 112 also can include other information such as likes and dislikes associated with one or more users of the social networking service, comments associated with or generated by one or more users of the social networking service, connection requests associated by or generated by one or more users of the social networking service, and the like. It should be appreciated that the SN data 112 can include any type of social networking information, and that the examples listed above are illustrative.

According to various embodiments, the operating environment 100 includes a search engine 114 operating on or in communication with the network 104. The functionality of the search engine 114 can be provided by one or more applications, which can be executed by one or more devices and/or combinations of devices. In some embodiments, the functionality of the search engine 114 is provided by one or more server computers configured to execute various applications, though this is not necessarily the case.

In the illustrated embodiment, the functionality of the search engine 114 is provided by a web server configured to execute a search application and/or other applications (not illustrated). According to various implementations, the search engine 114 is configured to discover applications 106, SN servers 108, web sites, services, and/or other resources accessible via the network 104, to index the resources, to search the indexed resources, and/or to provide search results that meet or are deemed relevant to search queries and/or other requests for resources. For example, the search engine 114 can be provided to receive, parse, interpret, and execute search queries or other requests, and to provide search results that satisfy and/or are relevant to the queries. As such, it should be understood that the search engine 114 can be configured to apply natural language processing and/or other logic to identify search terms in and/or otherwise interpret search queries.

According to various implementations, search results can be passed to searchers or other entities via search result pages, which can include, for example, links to identified documents, files, applications 106, SN applications 108, and/or other resources, and the like. The search engine 114 also can be configured to track search histories and/or other usage associated with the search engine 114, if desired, for various analytics and/or metrics tracking and reporting, and/or for use in providing services via other nodes or devices in communication with the search engine 114, as will be described in more detail herein. If the search engine 114 is configured to provide analytics and/or metrics tracking functionality, users can be provided with opportunities to opt-in and/or opt-out of the functionality to address perceived privacy and/or security concerns. Similarly, all usage information can be anonymized before storing or using the information to address security and/or privacy concerns.

According to various embodiments, search data 116 including search results, search histories, search trends, search result trends, search analytics and/or metrics, browsing and/or other information can be generated or stored by the search engine 114. The search data 116 can be made available to, transmitted to, and/or retrieved by one or more devices in communication with the search engine 114 such as, for example, a profile engine 118 operating on or in communication with the network 104, and can be used for various purposes. Some exemplary uses of the search data 116 are described in more detail herein.

The profile engine 118 is configured to provide the functionality described herein for generating aggregated profiles and providing an online concierge. Additionally, the profile engine 118 is configured to generate, store, modify, and provide data relating to the aggregated profiles, to generate, store, modify, and provide user interfaces (“UIs”) for interacting with the data describing the aggregated profiles, to use the aggregated profiles for various purposes including, but limited to, an online concierge service, to track usage of devices communicating with or via the profile engine 118, and to provide other functionality. In the illustrated embodiment, the profile engine 118 is configured to execute a profile module 120, a concierge application 122, a tracking application 124, and other applications and modules (not illustrated) to provide these and other functionality.

The profile module 120 is configured to create and maintain one or more profiles 126 associated with users or other entities. The profile module 120 also is configured to support the modification of data in the profiles 126, as well as aggregation of data into the profiles 126, if desired. More particularly, the profile module 120 can be authorized by a user to track certain activity occurring at one or more devices associated with a user. According to various embodiments described herein, the profile module 120 is configured to track usage of a client 128 associated with a user. This example is illustrative, and should not be construed as being limiting in any way.

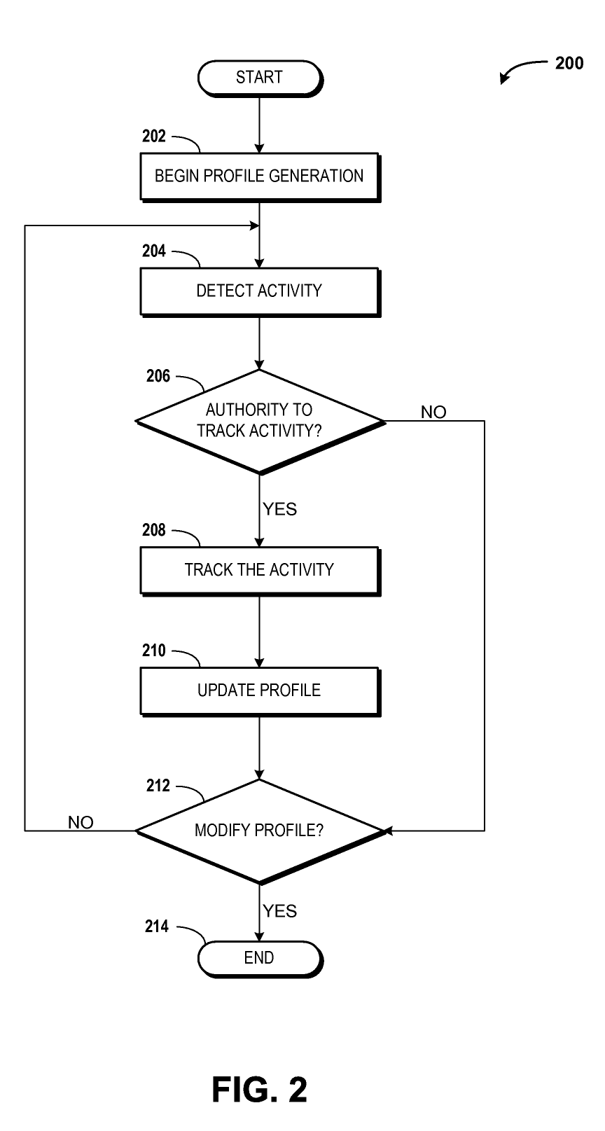

The profile module 120 can be executed by the profile engine 118 to collect data describing activity at the client 128 and/or activity associated with the client 128, as will be described in more detail herein, particularly with reference to FIG. 2. The profile module 120 also is configured to generate and provide one or more UIs to users or other entities, via which the entities can modify data stored in the profiles 126, create profiles 126, manage data stored in the profiles 126, and/or take other actions with respect to the profiles 126. The data in the profiles 126, as well as data for generating the UIs for interacting with the data stored in the profiles 126, cart be provided to the client 128 as profile information 130, if desired. Similarly, input 132 associated with the client 128, such as data generated by the client 128 for modifying the data in the profiles 126, can be received from the client 128. These and other features of the profile engine 118, which cart be provided, if desired, by execution of the profile module 120 by the profile engine 118, are described in more detail herein, particularly with reference to FIGS. 2-5.

The concierge application 122 is configured to recognize a desire, need, use, or request for information relating to the profiles 126, and to use the information and/or provide the information to the requesting entity in certain circumstances. More particularly, the concierge application 122 is configured to provide information in the profiles 126, if authorized by a user associated with the profiles 126, to requesting entities. In some embodiments, the concierge application 122 recognizes an explicit request for the information in the profile 126, for example, by receiving an explicit request for the information from an entity in communication with the profile engine 118. In some embodiments, the concierge application 122 recognizes an implicit request for the information in the profile 126 by recognizing that information requested by an application, web site, service, user, or the like, is included in the profiles 126. In other environments, the concierge application 122 recognizes that information in the profile 126 may be used for a particular purpose.

Thus, the concierge application 122 is configured to recognize the request or use for the information, to determine if the requested information is available, and if so, to determine if the concierge application 122 is authorized to use the information or to share the requested information with the requesting entity. The concierge application 122 also can generate one or more UIs for informing a user that the information is requested, for displaying the information that will be shared, and for allowing one or more authorized entities to modify the information that will be shared, if any. The UIs for informing the user, as well as the data from the profile 126, can be provided to the client 128 as the profile information 130, as explained above. These and other features of the profile engine 118, which can be provided, if desired, by execution of the concierge application 122, are described in more detail herein, particularly with reference to FIGS. 2-5.

The tracking application 124 is configured to track usage associated with the client 128 and/or other entities or devices communicating with the profile engine 118. According to various embodiments, the tracking application 124 provides functionality for tracking usage of the client 128 and/or usage associated with a user of the client 128 such as, for example, social network usage, search usage, and the like. As will be explained in more detail below with reference to FIGS. 2-5, users or other entities associated with the client 128 can opt-in and/or opt-out of the tracking functionality described herein, and/or specify or limit the types of activity tracked by the tracking application 124, if desired, it should be understood that in some embodiments, the tracking application 124 tracks input 132 associated with the client 128, wherein the input 132 includes input generated by the client 128 for submission to the server computer 102, the SN server 108, the search engine 114, the profile engine 118, and/or other entities. These and other features of the profile engine 118, which can be provided, if desired, by execution of the tracking application 124, are described in more detail herein, particularly with reference to FIGS. 2-5.

According to various embodiments, the client 128 includes a personal computer (“PC”) such as a desktop, tablet, laptop or netbook computer system. The client 128 also includes, in various implementations, other types of computing systems including, but not limited to, server computers, handheld computers, embedded computer systems, personal digital assistants, mobile telephones, smart phones, set top boxes (“STBs”), gaming devices, and/or other computing devices. Although not illustrated in FIG. 1, it should be understood that the client 128 can communicate with the profile engine 118 via the network 104.

The client 128 is configured to execute an operating system 134 and application programs 136. The operating system 134 is a computer program for controlling the operation of the client 128, and the application programs 136 are executable programs configured to execute on top of the operating system 134 to provide various functionality associated with the client 128. According to various embodiments, the operating system 134 executed by the client 128 is a native operating system such as the WINDOWS family of operating systems from Microsoft Corporation of Redmond, Wash. and/or a web-based operating system. Thus, it will be understood that according to various embodiments, the client 128 can be configured or equipped to execute traditional native applications and/or programs at the client-side, and/or to access applications such as the applications 106, which can include remotely-executed applications such as web applications and/or other remote applications. Similarly, it should be understood that the client 128 can execute web-based operating systems and/or applications, as well as native operating systems and/or applications, and that such functionality can, but is not necessarily, accessible via various boot modes.

Additionally, the client 128 can be configured to receive and render data generated by the applications such as the application 106 or the SN application 110. The client 128 also can be configured to receive and render the search data 116, data associated with the profile engine 118, and the like. In some embodiments, as mentioned above, the client 128 receives profile information 130 from the profile engine 118. The profile information 130 can include data describing the profiles 126, UIs for interacting with the profiles 126, data generated by or relating to the concierge application 122, and the like.

The client 128 can receive these and other data or content such as web pages, files, and the like, some, all, or none of which can be rendered by the operating system 134 or the application programs 136 executed by the client 128. In some implementations, the client 128 is configured to access remotely-executed applications and/or to execute local code such as scripts, local searches, and the like. As such, the client 128 can be configured to access or utilize cloud-based, web-based, and/or other remotely executed applications, and/or to render data generated by the application 106, the SN applications 110, the search engine 114, the profile engine 118, and/or data associated with web pages, services, files, and/or other content.

The application programs 136 can include programs executable by the client 128 for accessing and/or rendering content such as web pages and the like, programs for accessing, executing, and/or rendering data associated with various native and/or web-based applications, and/or programs for accessing, executing, and/or rendering data associated with various services. In other embodiments, the application programs 136 include stand-alone or runtime applications that are configured to access web-based or remote resources and/or applications via public or private application programming interfaces (“APIs”) and/or public or private network connections. Therefore, the application programs 136 can include native and/or web-based applications for providing or rendering data associated with locally-executed and/or remotely-executed applications.

Although not illustrated in FIG. 1, it should be understood that the client 128 can communicate with the server computer 102, the SN server 108, the search engine 114, and/or the profile engine 118 via a direct link or data pipeline and/or via one or more networks or network connections such as the network 104. Furthermore, while FIG. 1 illustrates one server computer 102, one network 104, one SN server 108, one search engine 114, one profile engine 118, and one client 128, it should be understood that the operating environment 100 can include multiple server computers 102, multiple networks 104, multiple SN servers 108, multiple search engines 114, multiple profile engines 118, and/or multiple clients 128. Thus, the illustrated embodiments should be understood as being exemplary, and should not be construed as being limiting in any way.

Turning now to FIG. 2, aspects of a method 200 for generating an aggregated profile will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods disclosed herein, and/or substantially equivalent operations, can be performed by execution of computer-readable instructions included on a computer-storage media, as defined above. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof.

For purposes of illustrating and describing the concepts of the present disclosure, the method 200 disclosed herein is described as being performed by the profile engine 118 via execution of one or more modules and/or applications such as the profile module 120, the concierge application 122, and/or the tracking application 124. It should be understood that this embodiment is exemplary, and should not be construed as being limiting in any way. Other devices and/or applications can be configured to generate the aggregated profile disclosed herein without departing from the scope of the claims.

The method 200 begins at operation 202, wherein the profile engine 118 receives a command to generate a profile 126. The command to generate the profile 126 can be received explicitly, for example by a user of the profile engine 118 explicitly selecting an option to generate the profile 126. Additionally, or alternatively, the command to generate the profile 126 can be implicitly generated, for example, by a user or entity selecting an option to allow generation of the profile 126 at a particular time or during a particular activity, by opting-in to profile generation functionality, by authenticating or logging in to the profile engine 118, and/or via other actions or activities other than explicitly requesting generation of the profile 126.

Additionally, or alternatively, the profile generation functionality of the profile engine 118 can be invoked by one or more of the application 106, the SN application 110, the search engine 114, the operating system 134, and/or the application program 136. In one contemplated embodiment, a user logs into the client 128, and the client 128, in turn, issues a command to the profile engine 118 to begin generating the profile 126. These and other methods and functionality for invoking the profile generation functionality of the profile engine 118 are possible and are contemplated.

From operation 202, the method 200 proceeds to operation 204, wherein the profile engine 118 detects activity at a device associated with a profile 126. For purposes of describing the concepts and technologies disclosed herein, the detected activity is described as being associated with the client 128, though this is not necessarily the case. As will be appreciated from the description above with regard to operation 202, the activity detected in operation 204 can include various activities at the client 128 and/or associated directly or indirectly with the client 128.

In some embodiments, the activity detected in operation 204 includes the client 128 accessing or executing the application 106, the SN application 110, and/or other resources or content. In other embodiments, the activity detected in operation 204 includes receiving and/or rendering data at the client 128, for example, data associated with the application 106, the SN data 112, the search data 116, and/or other data. In yet other embodiments, the activity detected in operation 204 includes one or more interactions at the client 128 with a native application, a remotely executed application, and/or applications executed at the client 128 in-part and at a remote device in-part.

According to various implementations, the activity detected in operation 204 includes interaction with content such as Internet content, web pages, files, multimedia, applications 106, SN applications 110, SN data 112, search data 116, advertising, games, articles, blogs, and the like. For example, the profile engine 118 may detect the loading of a web page at the client 128, which may include the resolution of a domain name, accessing a web server such as the server computer 102 to access the desired data, receipt of the desired data at the client 128, and/or rendering and displaying the received data at the client 128. This example is illustrative, and should not be construed as being limiting in any way. More particularly, as explained above, the client 128 can include a device executing a web-based OS. As such, in some embodiments some, all, or no activity associated with the client 128 can occur over one or more networks such as the network 104. As such, the profile engine 118 can be configured to detect some, all, or no activity occurring at the client 128, and therefore, some, all, or no activity occurring at the client 128 can be detected in operation 204.

In an exemplary embodiment, the client 128 interacts with a messaging application such as a chat program, an email program, a VoIP program, and the like. These and other messaging programs can be provided via execution of one or more applications such as the application 106, which can be remotely executed, locally executed, and/or remotely-executed-in-part and locally-executed-in-part at the client 128 and/or a server such as the server computer 102. The operation 204 can include, for example, recognizing the type of communication occurring at or via the client 128, parties and/or content associated with the communications, if authorized, and/or other aspects associated with the communications. These and other exemplary activity will be more fully understood with reference to the description herein.

From operation 204, the method 200 proceeds to operation 206, wherein the profile engine 118 determines if the profile engine 118 has authority to track the activity detected in operation 204. The determination of operation 206 may be made at any time and can be specified by users of the client 128. Additionally, or alternatively, the profile engine 118 can notify the client 128 that the profile engine 118 is prepared to track activity, and to solicit authorization to proceed with the tracking. As such, it will be understood that authorization to track some, all, or no activity detected in operation 204 may be given at any time.

According to other embodiments, the profile engine 118 is configured to access permissions data, which can be stored with, or separate from, the profiles 126. The permissions data can specify not only what information the profile engine 118 is and/or is not authorized to use or share, but also what uses the profile engine 118 is authorized to use the information for, entities with which the information can be shared, and the like. Thus, the permissions data can define on a broad or granular level, permissions associated with the profiles 126.

If the profile engine 118 determines that the profile engine 118 has authority to track the activity detected in operation 204, the method 200 proceeds to operation 208, wherein the profile engine 118 begins tracking the activity and/or information relating to the activity. According to various embodiments, the tracking illustrated in operation 208 includes accessing and/or mining data from third party services or resources accessed or executed at, via, or by the client 128, as is described in more detail herein. For example, if the client 128 accesses a web site, the profile engine 118 may track that access and generate data relating to that particular activity. Similarly, if the client 128 accesses, executes, or otherwise interacts with the application 106, the profile engine 118 may track that access or execution, and may store data relating to that interaction. As explained above, the tracking of these activities by the profile engine 118 can be explicitly granted for each activity, explicitly granted for all activities collectively, implicitly granted by opting-in to a service relating to the profiles 126 as disclosed herein, and/or otherwise granted. It should be recognized, that users, devices, and/or entities can opt-in and opt-out of the functionality described herein at any time to address perceived privacy and/or security concerns.

In some embodiments, a user or other entity associated with the client 128 grants authorization to the profile engine 118 to track some, all, or no activity occurring at or via the client 128. Thus, for example, the profile engine 118 can be authorized to not only detect interactions between the client 128 and SN data 112 stored or hosted by the SN server 108, but also detailed information detailing what kind of interaction occurs between the client 128 and the SN server 108, other parties to the interaction such as recipients of a message or comment, and the like. Similarly, the profile engine 118 can be authorized to receive and use the SN data 112 in generation of the profiles 126 and therefore may be authorized to track all activity associated therewith, if desired.

In other embodiments, the profile engine 118 is authorized to track some, all, or no browsing or other activity associated with the client 128, or to access browsing history or other activity from authorized third parties. For example, cookies or other technology for tracking browsing, clicking, and/or other activity can be tracked by third parties. If a user or other authorized entity associated with the client 128 authorizes the profile engine 118, the profile engine 118 can be configured to access this information and use that information in generating the profile 126. Furthermore, the search data 116 can include searching history, advertising and ranking information associated with search histories, and the like. These and other data can be used by the profile engine 118, if authorized, to generate the profiles 126. It should be understood that the above examples of information and data are illustrative, and that other information tracked by the profile engine 118 and/or obtained from authorized third party entities can be used by the profile engine 118 in generation of the profiles 126. Thus, the tracked information can include, but is not limited to, browsing history, application usage history, search history, advertising history, login history, usage history, social networking information and histories, and the like, some, all, or none of which can be tracked by the profile engine 118 and/or obtained by the profile engine 118 from authorized third party entities.

From operation 208, the method 200 proceeds to operation 210, wherein the profile engine 118 updates the profiles 126 with data describing or relating to the information tracked in operation 208. The data describing the tracked information can be stored in various levels of detail. For example, the tracked information can be generalized by the profile engine 118 and stored as a generalized description of the tracked activity, or the information can be stored in a form that describes the activity in specific terms.

In one exemplary embodiment, the activity tracked in operation 208 includes a user of the client 128 accessing an email messaging application and sending an email message to a particular recipient. If the information describing the tracked activity is described in specific terms, the information can describe, for example, a recipient of the email message, a length of the email message, and/or other information relating to the email message. If the information describing the tracked activity is stored as a generalized description of the tracked activity, the information can include, for example, a time of day at which the email application was accessed, the type of activity engaged in with the email application and the like. Thus, the profile engine 118 can store general information such as usage patterns, or specific information such as email history between one or more entities. This example is illustrative, and should not be construed as being limiting in any way.

From operation 210, or if the profile engine 118 determines in operation 206 that the profile engine 118 is not authorized to track the activity associated with the client 128, the method 200 proceeds to operation 212 wherein the profile engine 118 determines if the profile 126 should be modified. The profile engine 118 may determine that the profile 126 should be modified, for example, if activity at and/or associated with the client 128 is continuing. Additionally, or alternatively, it should be understood that the profile engine 118 can receive a command to modify an existing profile 126. As such, the methodology described herein can begin with an operation substantially similar to the operation 212.

It will be appreciated that the profile 126 can include an aggregation of a wide variety of information relating to a wide variety of activities. Furthermore, it will be appreciated that the information relating to the activities can be stored in general and/or specific terms, depending upon various concerns, needs, or preferences. As such, the profile 126 can be generated over time based upon an aggregation of tracked information and relating to an aggregation of tracked activity.

If the profile engine 118 determines in operation 212 that the profile 126 should be modified, the method 200 returns to operations 204 and iterates the operations 204-212 may be iterated to modify the profile 126 and/or to aggregate additional information for adding to the profile 126. If the profile engine 118 determines, in any iteration of operation 212, that the profile 126 should not be modified, the method 200 proceeds to operation 214. The method 200 ends at operation 214.

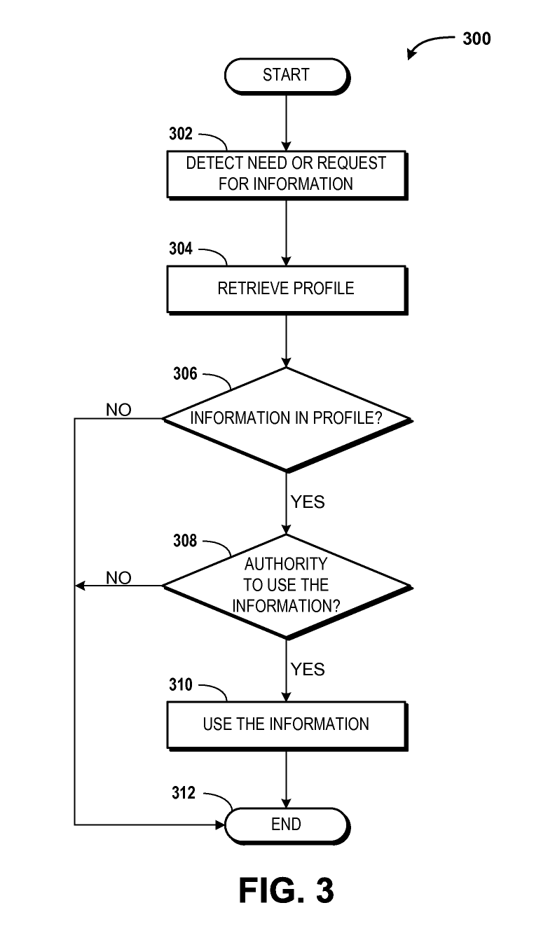

Turning now to FIG. 3, a method 300 for using an aggregated profile is described in detail, according to an exemplary embodiment. For purposes of illustration, and not limitation, the method 300 is described as being performed by the profile engine 118. It should be understood that this embodiment is exemplary, and should not be construed as being limiting in any way. Other devices and/or applications can be configured to use the aggregated profile disclosed herein without departing from the scope of the claims.

The method 300 begins at operation 302, wherein the profile engine 118 detects a proposed use for information included in an aggregated profile. In the illustrated embodiment, the aggregated profile is described as including or being a profile 126, and the profile 126 is described as relating to the client 128 and/or a user of the client 128. It should be understood that this embodiment is exemplary, and is relied upon merely to describe in additional detail the concepts and technologies disclosed herein. As such, this embodiment should not be construed as being limiting in any way.

According to various embodiments, the profile engine 118 detects a proposed use for the information included in the profile 126 via detection of an opportunity to drive advertising to the client 128. More particularly, the profile engine 118 may be authorized by a user of the client 128 to share aspects of the profile 126 with one or more devices that generate advertising. For example, the search engine 114 may include an advertising module or application that generates or inserts advertising into the search data 116. The search engine 114 may rely upon its own information such as inference, natural language processing, and the like, and/or the search engine 114 may request from the profile engine 118 aspects of the profile 126 upon which advertising can be based.

In another contemplated embodiment, a user or other authorized entity may authorize the profile engine 118 to share aspects of the profile 126 with sites or services based upon implicit or explicit requests for the information. For example, if an accessed web page includes a search form that prompts a user for his or her geographic location before proceeding to a second form, the profile engine 118 can be authorized to recognize this request, and to submit the requested information to the web site, if authorized by the client 128 or a user thereof, to streamline the process of arriving at the second form.

In yet another contemplated embodiment, a user may access a social networking service, for example a social networking service associated with the SN server 108, and the SN application 110 may request personal information associated with the user of the client 128 to drive advertising, suggestions, applications, and the like, to the client 128. In some embodiments, the SN application 110 generates the advertising, suggestions, and the like via logic executed by the SN application 110. In other embodiments, the SN application 110 relies upon aspects of the profile 126 to provide these and other features to the user. It should be understood that the above examples are illustrative, and that other needs, uses, and/or requests for information in a profile 126 are possible and are contemplated.

From operation 302, the method 300 proceeds to operation 304, wherein the profile engine 118 retrieves the profile 126 associated with the client 128. It will be appreciated that the profile engine 118 can identify the appropriate profile based upon various identifying information associated with the client 128. For example, the profile engine 118 may recognize an Internet protocol (“IP”) address associated with the client 128, a login, password, access code, or other authentication information associated with the client 128, a media access control (“MAC”) address associated with the client 128, a geographic location associated with the client 128, an international mobile equipment identity (“IMEI”) or international mobile subscriber identity (“IMSI”) associated with the client 128, other identifying information, and the like. The profile engine 118 can query the profiles 126 to identify one or more profiles 126 corresponding to the identifying information obtained for the client 128. Additionally, or alternatively, in some embodiments, the client 128 connects to or via the profile engine 118, and the profile engine 118 therefore can be configured to recognize or remember the identity of the client 128 via a direct connection between the two entities. These examples are illustrative, as other methods for determining a profile 126 relating to a client 128 are contemplated and are known. It also should be understood that the profile engine 118 can, but does not necessarily, perform disambiguation processes to identify the profile 126 associated with the entity.

From operation 304, the method 300 proceeds to operation 306, wherein the profile engine 118 determines if the requested information is included in the profile 126. The profile engine 118 is therefore configured to determine the requested information, and to parse, interpret, and/or otherwise search through the profile 126 to determine if the requested information is present in the profile 126. For example, if the requested information includes a request for an age associated with a user of the client 128, the profile engine 118 can search the profile 126 to determine if the age of the user is known. This example is illustrative and should not be construed as being limiting in any way.

If the profile engine 118 determines in operation 306 that the requested information exists in the profile, the method 300 proceeds to operation 308, wherein the profile engine 118 determines if the profile engine 118 has the authority to use or share the information. As explained above with respect to operation 206 of FIG. 2, the profile engine can access permissions data to determine if the profile engine 118 has authority to use or share the information. In some instances, the profile engine 118 is able to determine specific information in the profile 126 that may be used or shared. In other embodiments, the profile engine 118 is configured to determine that the profile engine 118 is or is not authorized to use or share a category or type of information corresponding to the information in the profile 126. In still other embodiments, the profile engine 118 is configured to interact with the client 128 to determine if the profile engine 118 is authorized to use or share information.

If the profile engine 118 determines in operation 308 that the profile engine 118 has authority to use or share the requested information, the method 300 proceeds to operation 310, wherein the profile engine 118 uses the information or shares the information with the requesting entity. Although not illustrated in FIG. 3, it should be understood that in some embodiments, the information is anonymized prior to sharing the information with the requesting entity to address privacy and/or security concerns. For example, if the requested information relates to a name of the user, privacy or security considerations may dictate that only a first name is shared with requestors. Other examples of anonymizing or limiting disclosure of the information are possible and are contemplated.

From operation 310, the method 300 proceeds to operation 312. Similarly, if the profile engine 118 determines in operation 306 that the requested information is not available in the profile 126, the method 300 proceeds to operation 312. Also, if the profile engine 118 determines in operation 308 that the profile engine is not authorized to use or share the information, the method 300 proceeds to operation 312. The method 300 ends at operation 312.

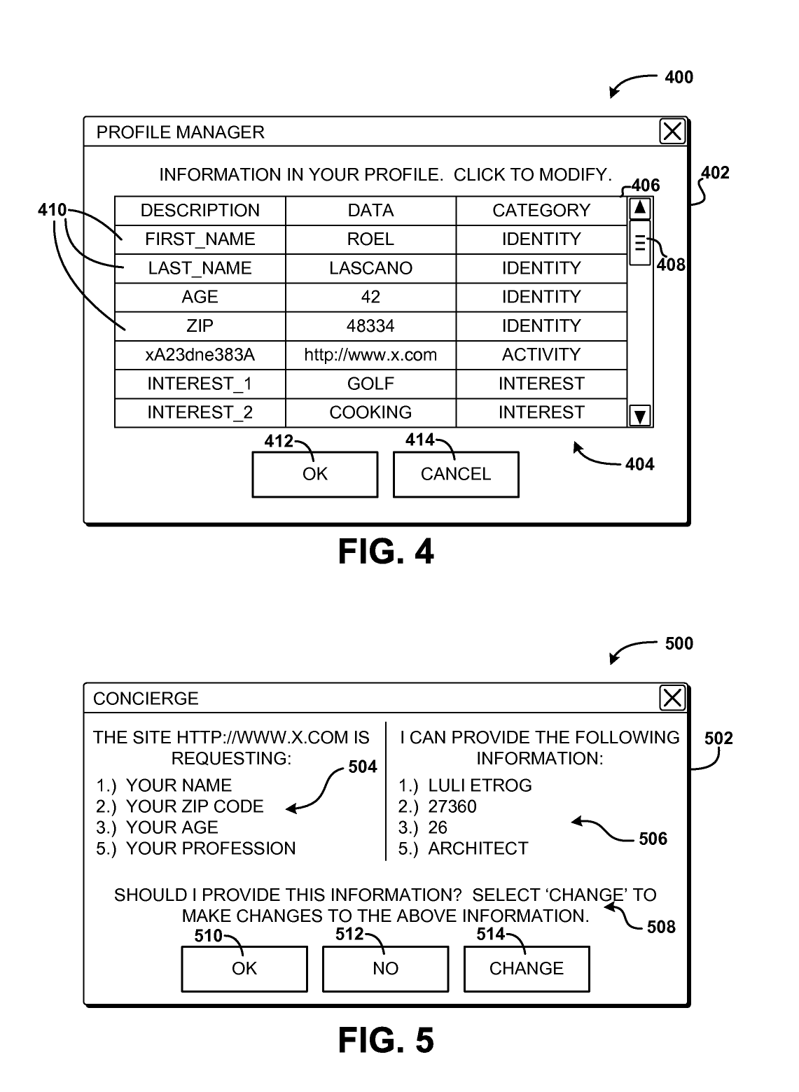

Turning now to FIG. 4, a user interface diagram showing aspects of a user interface (UI) for modifying the information included in an aggregated profile in one embodiment will be described. In particular, FIG. 4 shows a screen display 400 generated by one or more of the OS 130 and/or the application programs 136 executed by the client 128 according to one particular implementation presented herein. It should be appreciated that the UI diagram illustrated in FIG. 4 is exemplary. Furthermore, it should be understood that data corresponding to the UI diagram illustrated in FIG. 4 cart be generated by the profile engine 118, made available to or transmitted to the client 128, and rendered by the client 128, though this is not necessarily the case. In some embodiments, a UI diagram such as the UI diagram illustrated in FIG. 4 is presented in conjunction with the modification of a profile 126 as discussed above with reference to operation 212 of FIG. 2, though this is not necessarily the case.

In the illustrated embodiment, the screen display 400 includes a profile modification window 402. In some implementations, the profile modification window 402 is displayed on top of or behind other information (not illustrated) displayed on the screen display 400. Additionally, or alternatively, the profile modification window 402 can correspond to an application window that fills the screen display 400 and/or is sized to fit a desired portion or percentage of the screen display 400. It should be understood that the illustrated layout, proportions, and contents of the illustrated profile modification window 402 are exemplary, and should not be construed as being limiting in any way.

The profile modification window 402 includes a profile information display area 404, which can be formatted by the profile engine 118 and/or an application executed thereby such as, for example, the profile module 120. In the illustrated embodiment, the requested information area 404 is displaying information retrieved from a profile 126 associated with a user of the client 128. The requested information area 404 can be configured to display various levels of detail, if desired. The requested information area 404 includes a table 406 displaying data associated with the profile 126, and a UI control 408 for scrolling through the table 406. It should be appreciated that the illustrated contents and layout of the requested information area 404 are exemplary, and should not be construed as being limiting in any way.

In the illustrated embodiment, the table 406 includes a number of fields 410, some of which are labeled in FIG. 4. Each of the fields 410 corresponds to a UI control for modifying the data displayed in the respective field 410, though this is not necessarily the case. As such, a user or other authorized entity associated with the profile 126 can modify the data stored in the profile via the profile modification window 402. In the illustrated embodiment, the profile modification window 402 includes a UI control 412, the selection of which causes the profile engine 118 to submit any changes made to the data displayed in the fields 410, and a UI control 412, the selection of which causes the profile engine 118 to discard any changes made to the data displayed in the fields 410. It should be understood that additional and/or alternative UI controls can be displayed on the profile modification window 402.

In the illustrated embodiment, the fields 410 are arranged into a number of columns. Each row of the table 406 corresponds to one fact associated with the client 128. For example, one row includes a session identifier in the description column, a URL associated with a resource accessed during the session, and a category identifier for the fact, illustrated as “Activity” in FIG. 4. As shown in FIG. 4, other category identifiers include, but are not limited to, an identity category relating to information identifying a user with whom the profile 126 is related, and an interest category relating to information identifying one or more interests associated with a user with whom the profile 126 is related. These categories are illustrative of how the facts illustrated in the filed 410 can be organized or categorized, and should not be construed as being limiting in any way. As such, it will be appreciated that the data in the table 406 can be arranged, used, stored, or shared as specific facts and/or types or categories of facts.

Turning now to FIG. 5, a user interface diagram showing aspects of a user interface (UI) for controlling the use or sharing of information front art aggregated profile in one embodiment will be described. In particular, FIG. 5 shows a screen display 500 generated by one or more of the OS 130 and/or the application programs 136 executed by the client 128 according to one particular implementation presented herein. It should be appreciated that the UI diagram illustrated in FIG. 5 is exemplary. As explained above with regard to FIG. 4, it should be understood that data corresponding to the UI diagram illustrated in FIG. 5 can be generated by the profile engine 118, made available to or transmitted to the client 128, and rendered by the client 128, though this is not necessarily the case. It also should be understood that the UI diagram illustrated in FIG. 5 can be presented in conjunction with the operation 308 described above with reference to FIG. 3, though this is not necessarily the case.

In the illustrated embodiment, the screen display 500 includes a notification window 502. In some implementations, the notification window 502 is displayed on top of or behind other information (not illustrated) displayed on the screen display 500. Additionally, or alternatively, the notification window 502 can correspond to an application window that fills the screen display 500 and/or is sized to fit a desired portion or percentage of the screen display 500. It should be understood that the illustrated layout, proportions, and contents of the illustrated notification window 502 are exemplary, and should not be construed as being limiting in any way.

The notification window 502 includes a requested information area 504, which can be formatted by the profile engine 118 and/or an application executed thereby such as, for example, the concierge application 122. In the illustrated embodiment, the requested information area 504 is displaying a notification to a user that a site is requesting information associated with the user. In addition to notifying the user of the request for information, the requested information area 504 can be configured to display details associated with the request for the requested information, as shown in FIG. 5. It should also be appreciated that the data in the requested information area 504 can be obtained from the profile 126 associated with the client 128, though this is not necessarily the case. It should be appreciated that the illustrated contents and layout of the requested information area 504 are exemplary, and should not be construed as being limiting in any way.

The notification window 502 also includes an available information area 506, which can be formatted by the profile engine 118 and/or the concierge application 122. In the illustrated embodiment, the available information area 506 is displaying a notification to a user that the profile engine 118 is able to provide information associated with the user. In addition to notifying the user of the available information, the available information area 506 can be configured to display details associated with the available information, as shown in FIG. 5. It should be appreciated that the illustrated contents and layout of the available information area 506 are exemplary, and should not be construed as being limiting in any way.

The notification window 502 also displays a request for instructions 508 from the user, in the illustrated embodiment, the request for instructions 508 informs the user that the information displayed in the requested information area 504 is requested from a site or application, that the information displayed in the available information area 506 can be provided to the site or application, and requests input from the user as to how the user wishes to proceed. In the illustrated embodiment, the notification window 502 includes a UI control 510, the selection of which causes the profile engine 118 to submit the available information to the requesting site or application, a UI control 512, the selection of which causes the profile engine 118 to not submit the available information to the requesting site or application, and a UI control 514, the selection of which causes the profile engine 118 to allow the user to modify the available information before allowing or denying submission of the information. It should be understood that selection of the UI control 514 can cause the profile engine 118 to display a UI for modifying the data in the profile 126. An exemplary UI for modifying the data in the profile 126 is illustrated and described above with reference to FIG. 4, though other embodiments are possible and are contemplated.

According to various embodiments of the concepts and technologies disclosed herein, users or entities pay to access the profile generation and/or modification functionality disclosed herein. Furthermore, users may pay to access the concierge services disclosed herein. In other embodiments, users are paid to use the profile generation and/or modification functionality disclosed herein as well as the concierge services disclosed herein. More particularly, in some embodiments, companies or advertisers may pay users to share their profiles 126 and/or aspects of their profiles 126 for market research, advertising targeting, recommendation of other services or goods, and the like.

According to some implementations, the functionality described herein for generating the profiles 126 can run in the background and/or can be explicitly invoked by a user, if desired. For example, in some embodiments a screen display includes an application window and a profile management window. The application window may display output or input associated with applications 106, SN applications 110, searches, web browsing, files, multimedia, and the like. The profile management window can display LI controls for accessing and/or controlling the profile engine 118 as disclosed herein, as well as in additional or alternative manners. In some embodiments, the profile management window includes a UI control for adding displayed information to a profile 126. For example, a user may explicitly add a displayed application, social networking information, multimedia file, document, service, or other content to his or her profile 126 to explicitly modify the profile 126 to include the displayed information. Additionally, or alternatively, the profile management window may display options to activate or deactivate activity tracking, as described herein. It should be understood that information that is not displayed also can be added to a profile, if desired.

Although not described in detail above, it should be understood that users can access information associated with various users' profiles 126, if desired and/or authorized. The use of multiple profiles 126 can provide additional services and features. For example, in one contemplated embodiment, a user wishes to purchase a gift for a spouse, friend, car family member. Functionality of the profile engine 118 can be explicitly or implicitly invoked for this purpose, if desired. In response to invoking this functionality, the profile engine 118 may retrieve a profile 126 associated with the user and/or a profile 126 associated with the person for whom the user wishes to purchase the gift.

In addition to examining interests, activity, and/or other information associated with the person for whom the user wishes to purchase a gift, the profile engine 118 also can access the user's profile 126 to determine what purchases match the user's profile. For example, if the user's profile 126 indicates that the user does not spend more than two hundred dollars at a time, the profile engine 118 can submit a price range indicating this fact to a shopping site or other resource used by the user to search for a gift to purchase. As explained above, the submission of this information may be completed with the user's authorization, and/or after presenting and soliciting modifications from the user, if desired. It should be understood that this example is illustrative, and should not be construed as being limiting in any way.

Similarly, the profile engine 118 can provide functionality for matching one user's interests with another user's interests. In one contemplated embodiment, a first user profile 126 indicates that the first user has recently searched for “purchase used TOYOTA SIENNA,” Similarly, a second user profile 126 indicates that the second user has recently searched for “sell TOYOTA SIENNA,” listed a “TOYOTA SIENNA” with a car selling agency such as AUTOTRADER or EBAY MOTORS, retrieved used car pricing from KELLEY BLUEBOOK or other comparable sites, or the like. The profile engine 118 can search profiles 126 for such similarities and, with authorization of both users, introduce the two users to one another and indicate the similarity that drove the introduction. This example is illustrative, and should not be construed as being limiting in any way.

According to various implementations, users associated with the profiles 126 can control permissions associated not only with the profiles in general, but also with specific data in the profiles 126. For example, as explained above, the data in the profiles 126 can be stored nm only as specific facts such as “accessed website ‘X’ on Jul. 4, 2010,” but also general information gleaned from the specific facts such as “user likes to access website ‘X.’” As such, users can access the information stored in the profiles 126 and determine whether particular facts are to be shared, whether categories of facts are to be shared, and/or with whom the facts and/or categories of facts are to be shared. Thus, users can be given control over permissions relating to the profiles 126 at a granular level.

Similarly, in some implementations, users can move data from the profiles into a “personal vault” or other suitable category of information. In one embodiment, the personal vault stores data that is never shared with any entity, other than the user himself. According to various implementations, the user or another entity can move data from his or her profile to a personal vault at any time, thereby ensuring that this data is never shared with anyone and/or tracked by any entity at any time. According to various embodiments, the personal vault portion of the profiles 126 is accessible only via use of key, password, login, certificate, and/or other access control mechanism, even in situations where the access is attempted from a device associated with an authorized entity.

It should be understood that browsing or searching history, and not only personal or confidential information, may be placed in a personal vault. For example, a user may wish to move search information indicating recent searches for a particular type of doctor, a divorce attorney, or other search information to the personal vault to address privacy or other concerns. Thus, any future browsing or search information relating to these terms or concepts can be explicitly disallowed from inclusion in the profile 126. These examples of permissioning and access control are exemplary, and should not be construed as being limiting in any way.

As mentioned above, the profile engine 118 can be authorized to track various forms of activity and/or communications associated with the client 128. In some embodiments, messaging or communications are interpreted by the profile engine 118 to generate implicit social networks. For example, the profile engine 118 may recognize that a user interacts frequently with particular entities that are not part of an explicit social network, as determined by examining the SN data 112 and/or by other methods. In these and other situations, the profile engine 118 can create an implicit social network and/or suggest entities for addition to the user's explicit social network with information indicating why the suggestion is made. This example is illustrative, and should not be construed as being limiting.

Some embodiments of the concepts and technologies disclosed herein are used to funnel users to particular sites or resources. For example, advertisers, application developers, and/or other entities may pay to have users with particular information in their profiles 126 directed to their respective sites, applications, and/or other resources. As such, the profile engine 118 can suggest particular resources to users or other entities when profile information matches particular terms or other characteristics.

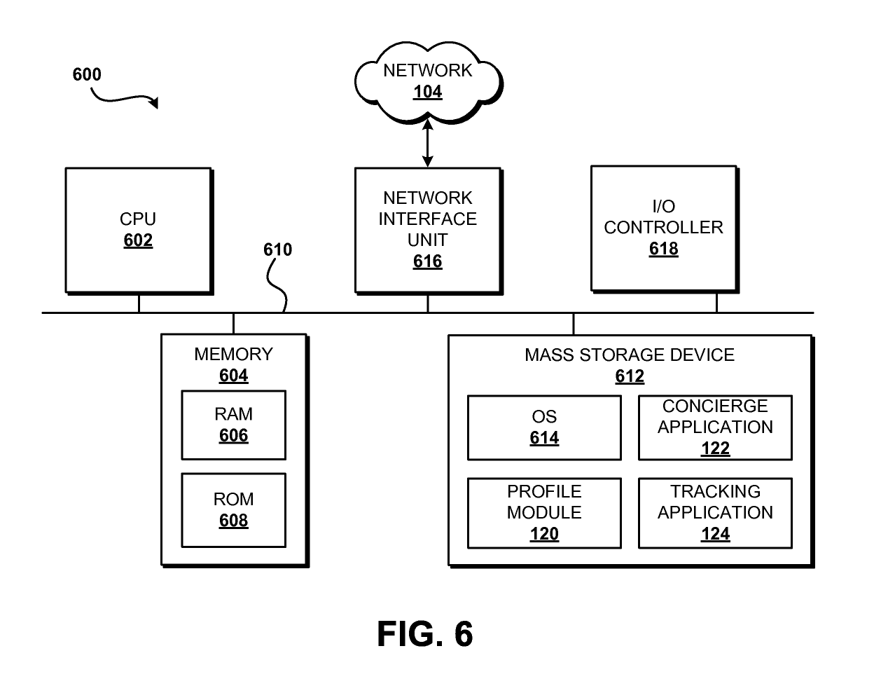

FIG. 6 illustrates an exemplary computer architecture 600 for a device capable of executing the software components described herein for generating an aggregated profile and providing an online concierge. Thus, the computer architecture 600 illustrated in FIG. 6 illustrates an architecture for a server computer, mobile phone, a PDA, a smart phone, a server computer, a desktop computer, a netbook computer, a tablet computer, and/or a laptop computer. The computer architecture 600 may be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing the operating system 614, the profile module 120, the concierge application 122, and the tracking application 124. Although not shown in FIG. 6, the mass storage device 612 also can be configured to store the SN data 112, the search data 114, and/or the profiles 126, if desired.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media that can be accessed by the computer architecture 600.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of this specification and the claims, the phrase “computer-readable storage medium” and variations thereof, does not include waves, signals, and/or other transitory and/or intangible communication media.

According to various embodiments, the computer architecture 600 may operate in a networked environment using logical connections to remote computers through a network such as the network 104. The computer architecture 600 may connect to the network 104 through a network interface unit 616 connected to the bus 610. It should be appreciated that the network interface unit 616 also may be utilized to connect to other types of networks and remote computer systems, for example, the client device 118. The computer architecture 600 also may include an input/output controller 618 for receiving and processing input from a number of other devices, including a keyboard, mouse, or electronic stylus (not shown in FIG. 6). Similarly, the input/output controller 618 may provide output to a display screen, a printer, or other type of output device (also not shown in FIG. 6).

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

Based on the foregoing, it should be appreciated that technologies for generating an aggregated profile and for providing an online concierge have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for modifying a profile, the computer-implemented method comprising performing computer-implemented operations for:
receiving, at a profile engine, a command to modify a profile associated with an entity;
detecting activity at a device associated with the profile;
determining if the profile engine is authorized to track information relating to the activity detected at the device;
in response to determining that the profile engine is authorized to track the information, tracking the information; and
modifying the profile based, at least partially, upon the information tracked.

2. The method of claim 1, wherein modifying the profile comprises generating a new profile based upon the information tracked.

3. The method of claim 1, further comprising in response to determining that the profile engine is not authorized to track the information, determining if modification of the profile is complete.

4. The method of claim 3, further comprising in response to determining that modification of the profile is not complete, detecting another activity at the device and determining if the profile engine is authorized to track information relating to the other activity detected at the device.

5. The method of claim 1, wherein determining if the profile engine is authorized to track the information comprises generating a user interface for presentation at the device for obtaining input indicating if the profile engine is authorized to track the information.

6. The method of claim 1, wherein determining if the profile engine is authorized to track the information comprises accessing permission data indicating if the profile engine is authorized to track the information.

7. The method of claim 1, wherein the activity detected at the device comprises access of data via execution of a web-based operating system at the device.

8. The method of claim 1, further comprising:
detecting a use for information, the information being associated with the entity;
retrieving the profile; and
determining if the profile comprises the information relating to the use.

9. The method of claim 8, further comprising in response to determining that the profile comprises the information relating to the use, determining if the profile engine is authorized to use the information.

10. The method of claim 9, further comprising using the information, in response to determining that the profile engine is authorized to use the information.

11. The method of claim 9, wherein determining if the profile engine is authorized to use the information comprises generating a user interface for display at the device, the user interface comprising a first control for indicating that the profile engine is authorized to use the information and a second control for indicating that the profile engine is not authorized to use the information.

12. The method of claim 11, wherein the user interface further comprises an area for displaying the information relating to the use and a third control for modifying the information relating to the use.

13. A computer-implemented method for modifying a profile, the computer-implemented method comprising performing computer-implemented operations for:
generating, at a device in communication with a profile engine, a command to modify a profile associated with the device;
executing an activity at the device, the activity comprising accessing data via execution of a web-based operating system at the device;
generating permission data indicating if the profile engine is authorized to track information relating to the activity executed at the device; and
submitting the permission data to the profile engine, wherein the profile engine is configured to track the information in response to determining that the permission data authorizes the profile engine to track the information, and wherein the profile engine is configured to modify the profile based, at least partially, upon the information tracked.

14. The method of claim 13, wherein the profile engine is further configured to modify the profile based, at least partially, upon social networking data associated with the entity.

15. The method of claim 13, wherein the profile engine is further configured to modify the profile based, at least partially, upon search data associated with the entity.

16. The method of claim 13, wherein the profile engine is further configured to modify the profile based, at least partially, upon an access history associated with access of a web-based application by the device.

17. The method of claim 13, wherein generating the permission data comprises
presenting, at the device, a user interface for obtaining input indicating if the profile engine is authorized to track the information, and
generating data corresponding to selection of one or more controls associated with the user interface.

18. The method of claim 13, further comprising displaying a user interface the device, the user interface comprising
a notification indicating that the profile engine has detected a use for information associated with the device,
a first control for indicating that the profile engine is authorized to use the information,
a second control for indicating that the profile engine is not authorized to use the information,
an area for displaying the information relating to the use, and
a third control for modifying the information relating to the use.

19. A computer-readable storage medium having computer readable instructions stored thereupon that, when executed by a computer, cause the computer to:
receive, at a profile engine, a command to modify a profile associated with an entity, the profile;
detect activity at a device associated with the profile, the activity comprising access of data via execution of a web-based operating system at the device;
determine if the profile engine is authorized to track information relating to the activity detected at the device;
in response to determining that the profile engine is authorized to track the information, track the information;
obtain social networking data associated with the device, search data associated with the device, and data indicating access of an application by the device; and
modify the profile based, at least partially, upon the information tracked, the social networking data, the search data, and the data indicating access of the application.

20. The computer-readable storage medium of claim 19, further comprising instructions that, when executed by the computer, cause the computer to:
detect a use for information, the information being associated with the entity;
determine if the profile comprises the information relating to the use;
in response to determining that the profile comprises the information relating to the use, determine if the profile engine is authorized to use the information;
in response to determining that the profile engine is authorized to use the information, use the information.
